(19) United States
(12) Patent Application Publication
(10) Pub. No.: US 2003/0161358 A1
(43) Pub. Date: Aug. 28, 2003

(54) Laser modulation and Q-switching using an inverse fabry-perot filter

(76) Inventor: Eric R. Mueller, West Suffield, CT (US)

Correspondence Address: STALLMAN & POLLOCK LLP, Suite 290, 121 Spear Street, San Francisco, CA, 94111, US

(21) Appl. No.: 10/085,611

(22) Filed: Feb. 26, 2002

(51) Int. Cl. H01S 3/11

(52) U.S. Cl. 372/10

(57) ABSTRACT

A laser includes an external modulation device including two spaced-apart wire-grids. The device has a reflectivity peak at a wavelength dependent on the spacing between the wire grids. The device is arranged to reflect and transmit radiation received from the laser. The reflected and transmitted radiation are modulated by varying the spacing between the wire-grid polarizers. The device may be used as an end mirror or a fold mirror of a laser resonator and operated as a Q-switch for the laser resonator. Q-switching is accomplished by varying the reflectivity of the device at the lasing wavelength from below to above a threshold reflectivity value for lasing.

### TECHNICAL FIELD OF THE INVENTION

The present invention relates generally to modulation and Q-switching of lasers. The invention relates in particular to modulation of gas lasers, particularly carbon dioxide (CO₂) lasers, having a fundamental wavelength of about 10 micrometers (μm).

### DISCUSSION OF BACKGROUND ART

Q-switching of a CO₂ laser is usually effected by either a passive Q-switch or an electro-optic (EO) Q-switch. Passive Q-switches have a particular shortcoming in that they have a relatively slow response time. This limits their use to Q-switching at relatively low rates, for example 5 Kilohertz (KHz) or less. Usually, the response time is sufficiently slow that they have a less than optimum Q-switching effect, i.e., the laser being Q-switched begins lasing before the Q-switch can be fully turned on.

A commonly used EO Q-switch for a CO₂ laser is a cadmium telluride (CdTe) Q-switch. This type of Q-switch has several shortcomings, including a high cost for the Q-switch itself and a high cost for driver electronics necessary to operate the Q-switch. Further, the CdTe material of the Q-switch exhibits thermal lensing effects that can lead to difficulties in maintaining a consistent beam quality and beam pointing in the laser. A discussion of the use of CdTe materials in laser systems can be found in U.S. Pat. No. 5,680,412, incorporated herein by reference.

There is a need for an alternate form of CO₂ laser Q-switch that can be operated at high switching rates, for example up to about 100 KHz, while avoiding above-discussed shortcomings of prior art Q-switches.

### SUMMARY OF THE INVENTION

In one aspect of the present invention, a laser comprises a laser resonator arranged to deliver radiation. A modulation device is provided and arranged to receive and modulate the laser radiation delivered by the laser resonator. The modulation device includes two spaced-apart wire-grid polarizers having variable spacing therebetween.

The spaced-apart wire grid polarizers are arranged to form a reflective device having a reflectivity and transmission that, at a predetermined wavelength of the laser can be varied by varying the spacing between the wire grid polarizers. Varying the spacing between the wire grid polarizers modulates the reflectivity and transmission of the reflective device and accordingly modulates the laser radiation reflected by and transmitted through the modulation device. The reflective device can be defined as a tunable inverse Fabry Perot (TIFP) filter inasmuch as it is characterized by narrow reflection bandwidth rather than a narrow transmission bandwidth.

In another aspect of the present invention, a laser comprises a laser resonator including at least one above-described reflecting device. Varying the spacing between the wire grid polarizers varies the reflectivity of the reflecting device at a predetermined lasing wavelength of the laser.

The reflecting device may be operated as a Q-switch for the laser resonator or for modulating the output of the laser resonator. In a straight resonator, the reflecting device is arranged as one end mirror of the laser resonator. In a folded resonator, the reflecting device may be arranged as a fold mirror or as an end mirror of the resonator.

In one preferred embodiment of the reflecting device and the modulating device, each of the wire-grid polarizers includes an array of parallel conductors aligned in a plane, with the planes of the conductor arrays aligned parallel to each other. The conductors in one of the arrays are aligned at an angle to the conductors in the other of the arrays. The alignment angle of the conductors is selectively variable. Varying the alignment angle varies the variation of reflectivity of the reflective device at the lasing wavelength per unit variation of the spacing of the wire-grid polarizers. In other words, the alignment angle variation varies the finesse of IFP filter. Varying the finesse varies both the width of reflectivity (and transmission) modulation and the co-alignment sensitivity of the wire grid polarizers for a given spacing variation.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIGS. 1 and 2 are respectively perspective and elevation views schematically illustrating a tunable inverse Fabry-Perot (TIFP) filter in accordance with the present invention including two spaced-apart wire-grid polarizers, one thereof movable with respect to the other by a piezoelectric transducer (PZT) for varying spacing between the polarizers.

FIG. 3 is graph schematically illustrating computed reflection response as a function of spacing of the wire grid polarizers of FIGS. 1 and 2 for two different azimuthal alignments of the polarizer grids.

FIG. 4 schematically illustrates a slab laser including a TIFP of FIGS. 1 and 2 for modulating an output beam of the laser.

FIG. 5 schematically illustrates a slab-laser having a laser resonator including a TIFP of FIGS. 1 and 2 arranged as an end-mirror of the resonator for Q-switching the laser.

FIG. 6 schematically illustrates a waveguide-laser having a folded laser resonator including a TIFP of FIGS. 1 and 2 for Q-switching the laser arranged as a fold-mirror of the resonator.

FIG. 7 schematically illustrates a waveguide-laser having a folded laser resonator including a TIFP of FIGS. 1 and 2 for Q-switching the laser arranged as an output-coupling mirror of the of the resonator.

### DETAILED DESCRIPTION OF THE INVENTION

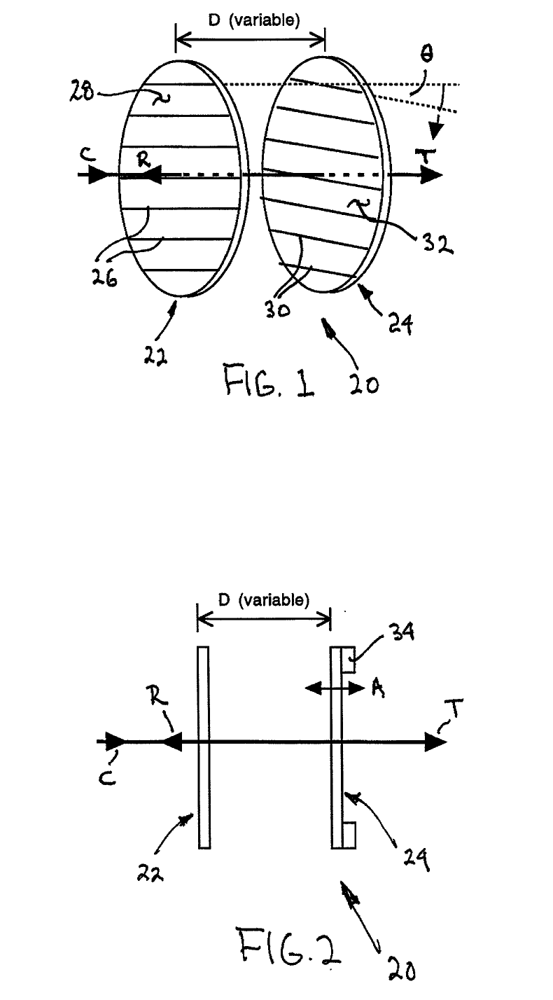

Referring now to the drawings, wherein like features are designated by like reference numerals, FIGS. 1 and 2 depict one example 20 of a TIFP. TIFP 20 includes two wire-grid polarizers 22 and 24. Wire grid polarizer 22 includes an array of parallel wires or conductors 26 arranged in a plane 28. Wire grid polarizer 24 includes an array of parallel wires or conductors 30 arranged in a plane 32. Planes 28 and 32 are arranged parallel to each other and are spaced apart by a distance D, which can be varied for tuning the filter. Preferably the distance D is varied by holding wire grid polarizer 22 in a fixed position and moving wire grid polarizer 24 as indicated in FIG. 2 by arrow A. This movement is preferably effected by one or more PZTs 34, however, other electromotive or length adjusting devices, such as magnetostrictive devices may be used to effect the movement without departing from the spirit and scope of the present invention. Laser radiation is incident on filter 20 as indicated by arrow C, and may be reflected (arrow R) or transmitted (arrow T) by the filter.

Wire grid polarizers 22 and 24 are arranged such that arrays of wires 26 and 30 therein are inclined to each other at an angle θ. Assuming that the wire grid polarizers are perfect, the transmission (T) through filter 20 of radiation polarized perpendicular to wires 26 of grid 22 is given by an equation:

T=4 cos² θ sin² kd/(sin⁴ θ+4 cos² θ sin² kD) (1)

where D is the spacing between wire grid polarizers 22 and 24 as defined above and k is the wavenumber of the radiation, i.e., the reciprocal of the wavelength of the radiation expressed in inverse centimeters (cm⁻¹). The reflection (R) of radiation from filter 20 is given by equation:

R=sin⁴ θ/(sin⁴ θ+4 cos² θ sin² kD) (2)

Examination of equation (2) reveals that a tunable filter 20 has a reflection as a function of wavelength consisting of a series of reflection peaks spaced apart by a wavelength range (free spectral range or FSR) determined by spacing D. The bandwidth of the reflection peaks increases, i.e., the finesse of the filter decreases, as angle θ is increased.

It should be noted here that the spacing of wires 26 and 30, for simplicity of illustration, is depicted as much wider than is the case in a practical wire-grid polarizer. Further while the term wires or conductors is used the wires are typically not conventional drawn wires or conductors, but are either lithographically formed from a metal layer on an infrared-transmitting substrate, or angle-deposited (shadow cast) onto peaks of a grating ruled or etched into in an infrared-transmitting substrate. Such polarizers are available commercially on a variety of infrared-transmitting substrates. One commercial supplier is The Optometrics Group, of Ayer, Mass.

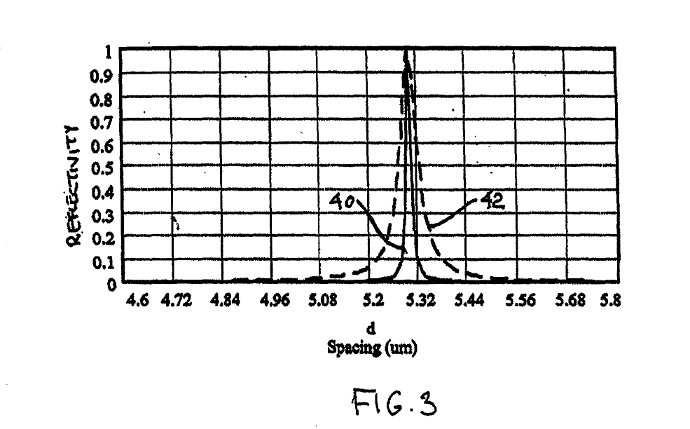

Referring now to FIG. 3, reflection of 10.6 μm radiation as a function of spacing D for values of angle θ of 5.0 degrees (curve 40) and 10.0 degrees (curve 42) for a “perfect” filter 20 is graphically depicted. The full widths at half maximum (FWHM) reflectivity of curves 40 and 42 are 0.012 μm and 0.052 μm respectively. A 95% reflection modulation would be provided by changes (ΔD) of 0.03 μm and 0.11 μm in spacing D for values of 5.0 degrees and 10.0 degrees respectively.

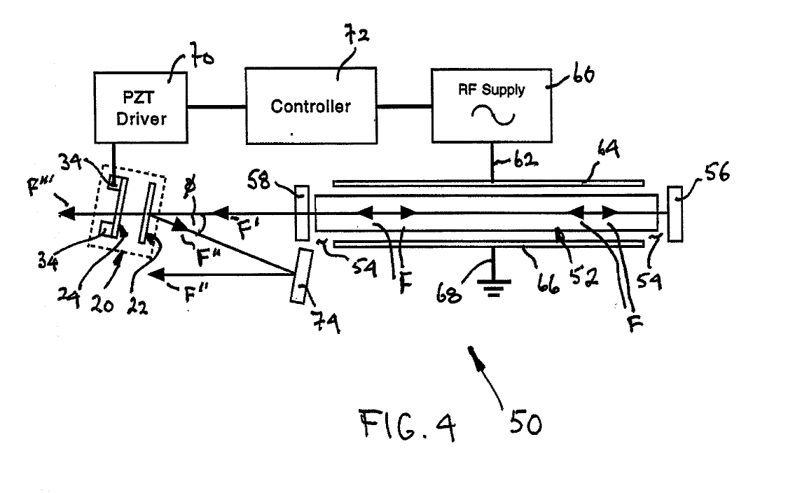

Referring now to FIG. 4 a laser 50 including a TIFP 20 arranged for modulating output power of the laser is schematically depicted. Laser 20 includes a gain-cell 52 including a gas such as carbon dioxide serving as a gain medium. Gain cell 52 is located in a laser resonator (resonant cavity) 54 terminated by mirrors 56 and 58. Gas in gain cell 52 is energized by application of RF potential from a power supply 60, via a connection 62, to an upper (slab) electrode 64. A lower (slab) electrode 66 is connected to ground via a connection 68. Mirror 56 is a maximally reflecting mirror and mirror 58 is a partially transmitting (output-coupling) mirror.

Laser radiation circulates in resonator 54 as indicated in FIG. 4 by double arrows F. Laser output radiation F′ is delivered from resonator 54 via output-coupling mirror 58 and is incident on wire grid polarizer 22 of filter 20. A PZT driver 70 drives piezoelectric transducer 34 for modulating output radiation F′. Operation of driver 70 and power supply 60 is controlled by a controller 72.

Filter 20 is inclined such that output radiation F′ is incident thereon at an angle φ. Filter 20 separates output radiation F′ into reflected and transmitted components F″ and F′″ respectively. An optional turning mirror 74 turns reflected component F″ in the same direction as transmitted component F′″. Inclining filter 20 at angle provides that the reflected component is not redirected into resonator 54. Reflected and transmitted components F″ and F′″ are modulated at a frequency determined by the drive frequency of filter 20. The depth of modulation is determined, inter alia, by the range of motion of wire grid polarizer 24, the value of angle φ and the wavelength location of the peak reflection response of filter 20 with respect to the wavelength of radiation F. Varying angle φ may be used to vary the depth of modulation for a fixed range of motion of wire-grid polarizer 24. By way of example, angle φ may be varied in a range between about 5° and 10°.

A relatively high modulation frequency, for example, about 100 KHz, is possible with TIFP filter 20. This makes it attractive for Q-switching a laser by using the filter as a mirror in a laser resonator. Indeed, as such a Q-switching operation would only require that the reflectivity of the filter be reduced below a threshold value lasing, for any given filter, a significantly shorter range of wire-grid polarizer motion than that necessary to provide 95% modulation would be required. Accordingly, Q-switching rates could be correspondingly faster than above described modulation rates. Q-switch sensitivity for a given range of motion may be adjusted by adjusting alignment angle θ of TIFP filter 20.

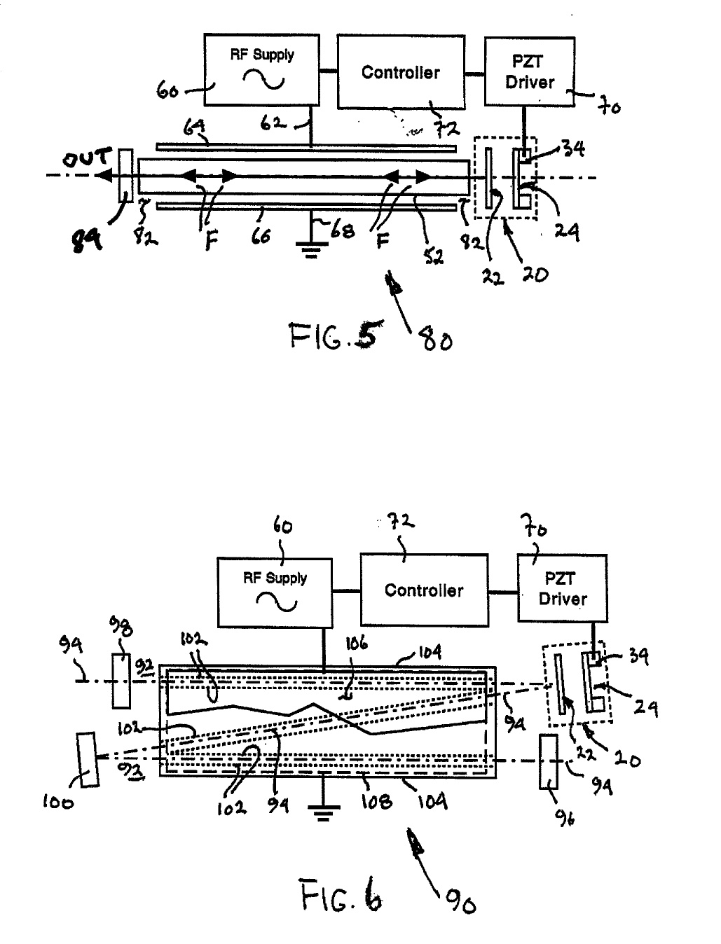

Referring now to FIG. 5, in one preferred embodiment 80 of a Q-switched laser in accordance with the present invention, a laser resonator 82 is terminated by TIFP filter 20 and mirror 84. Mirror 84 serves as an output-coupling mirror. Laser 80 includes a gain cell 52 including a lasing gas energized by an RF power supply 60 and electrodes 64 and 66 as described above for laser 40 of FIG. 4. Also as described above, filter 20 is driven by an RF driver 70, with operation of the RF driver and the RF power supply controlled by a common controller 72. Filter 20 is arranged and driven such that the reflectivity thereof periodically falls below and rises above a threshold value required for lasing.

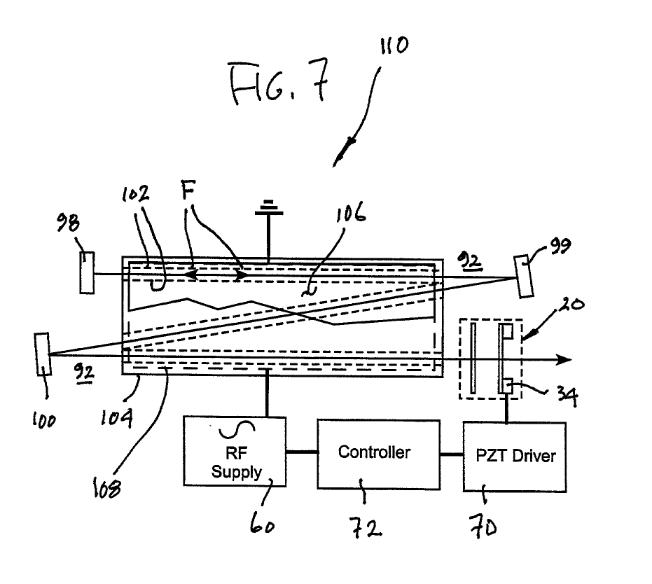

Another embodiment of a laser in which a TIFP filter 20 is used as a combined resonator mirror and Q-switch is schematically depicted in FIG. 6. Here, the laser 90 includes a laser resonator 92 having a longitudinal axis 94. Resonator 92 is terminated by mirrors 96 and 98. The resonator is a folded resonator having a longitudinal axis 94 folded into a Z-shape by filter 20 and a fold mirror 100. Laser 90 is of a type generally known as a waveguide laser. Waveguides are defined by channels in a ceramic block 104. These channels are indicated by dotted lines 102. Longitudinal axis 94 extends through the waveguides. Lasing gas in the waveguides is energized by an RF power supply 60 via upper and lower electrodes 106 and 108 respectively. Upper electrode 106 is only partially depicted. Lower electrode 108 is indicated by dashed lines.

Laser radiation (not explicitly shown) circulates in resonator 92 along longitudinal axis 94 thereof. Either of mirrors 96 and 98 may be used as an output-coupling mirror with the other used as a maximally reflecting mirror. Filter 20, here functioning as a fold mirror, is arranged and driven such that the reflectivity thereof periodically falls below and rises above a threshold value required for lasing. Operations of RF driver 70 and RF power supply 60 are controlled by a common controller 70, as described above with reference to laser 80 of FIG. 5.

Yet another embodiment of a laser in which a TIFP filter 20 is used as a combined resonator mirror and Q-switch is schematically depicted in FIG. 7. Here, a laser 110 is similar to laser 90 of FIG. 6 with an exception that the TIFP filter 20 is arranged as an end mirror of the resonator and a conventional mirror 99 is used, together with mirror 100 to fold the resonator axis of the laser. Laser radiation F circulates in the resonator along the resonator axis as indicated by arrows F. The reflectivity of TIFP 20 is varied between a sub lasing-threshold value and a value that is above the lasing threshold value but less than a peak value thereby allowing radiation F to be transmitted out of the laser as output radiation, i.e., TIFP functions as an output coupling mirror of the resonator as well as Q-switching the laser.

Those skilled in the art, from the description of the present invention provided above, will recognize without further illustration or detailed description that a folded resonator laser such as laser 110 could be configured with TIFP filter 20 used as an end mirror of the laser resonator but with mirror 98 used as an output coupling mirror. In such an arrangement, the reflectivity of TIFP 20 would preferably be varied between a sub lasing-threshold value and a value that is above the lasing threshold value and at peak reflectivity of the TIFP. Further, while folded resonator lasers 90 and 110 are described in terms of a twice folded resonator, the use of a TIFP filter 20 as a Q-switch is similarly applicable as an end mirror or a fold mirror in a laser resonator having only one fold, or having three or more folds.

In any above-discussed resonator configuration in which TIFP 20 is arranged as an end-mirror of the resonator, and in which the resonator is operated in a continuous wave (CW) mode, it is possible to use TIFP 20 for amplitude modulating the laser. This is accomplished by varying the reflectivity of the TIFP between a maximum value and a minimum value that are both greater than a threshold value required for lasing at a predetermined pumping power. The highest modulation frequencies obtainable, however, may be found to be somewhat less than the highest Q-switching frequencies for a corresponding TIFP and resonator configuration.

As TIFP filter 20 cannot be expected to be 100% efficient, the Q-switching arrangement of the present invention may most effectively be applied in high power, or high gain lasers that can tolerate a certain level of resonator losses while still delivering useful output power. Generally, it is believed that the Q-switching arrangement of the present invention will be easier to implement and will provide more flexibility and control than prior-art methods such as passive Q-switching and electro-optical Q-switching.

The present invention is described above in terms of a preferred and other embodiments. The invention is not limited, however, to the embodiments described and depicted. Rather, the invention is limited only by the claims appended hereto.

What is claimed is:

1. A laser comprising;
a laser resonator arranged to deliver radiation; and
a modulation device arranged to receive and modulate the laser radiation delivered by said laser resonator, said modulation device including two spaced-apart wire-grid polarizers having variable spacing therebetween.

2. The laser of claim 1, wherein radiation transmitted through said modulation device is delivered by the laser as modulated laser radiation.

3. The laser of claim 1, wherein laser radiation reflected from said modulation device is delivered by the laser as modulated laser radiation.

4. The laser of claim 1, wherein said wire-grid polarizers are arranged to form a reflective device having a reflectivity and transmission that, at a predetermined wavelength of the laser radiation, varies as a function of the spacing therebetween, whereby varying the spacing modulates the laser radiation reflected by and transmitted through the modulation device.

5. A laser comprising;
a laser resonator arranged to deliver radiation;
a modulation device arranged to receive and modulate the laser radiation delivered by said laser resonator; and
wherein, said modulation device includes two spaced-apart wire-grid polarizers having variable spacing therebetween, each of said wire-grid polarizers including an array of parallel conductors aligned in a plane, with said planes of said conductor arrays aligned parallel to each other and with conductors in one of said arrays aligned at an angle to conductors in the other of said arrays.

6. The laser of claim 5, wherein radiation transmitted through said modulation device is delivered by the laser as modulated laser radiation.

7. The laser of claim 5, wherein laser radiation reflected from said modulation device is delivered by the laser as modulated laser radiation.

8. The laser of claim 5, wherein said wire-grid polarizers are arranged to form a reflective device having a reflectivity and transmission that, at a predetermined wavelength of the laser radiation, varies as a function of the spacing therebetween, whereby varying the spacing modulates the laser radiation reflected by and transmitted through the modulation device.

9. The laser of claim 8 wherein said alignment angle of said conductors is selectively variable and said variation of reflectivity and transmission as function of spacing varies as a function of said alignment angle of said conductors.

10. A laser comprising:
a laser resonator including at least one reflecting device, said reflective device including two spaced apart wire-grid polarizers having variable spacing therebetween; and
wherein, varying the spacing between said wire grid polarizers varies the reflectivity of said reflective device at a predetermined lasing wavelength of the laser.

11. The laser of claim 10, wherein each of said wire-grid polarizers includes an array of parallel conductors aligned in a plane, with said planes of said conductor arrays aligned parallel to each other.

12. The laser of claim 11, wherein conductors in one of said arrays is aligned at an angle to conductors in the other of said arrays.

13. The laser of claim 12, wherein said alignment angle of said conductors is selectively variable, and wherein varying said angle varies the variation of reflectivity of said reflective device at said lasing wavelength per unit variation of the spacing of said wire-grid polarizers.

14. The laser of claim 10, wherein said reflective device forms an end-mirror of said laser resonator.

15. The laser of claim 10, wherein said laser resonator is a folded resonator and reflective device is a fold mirror of said laser resonator.

16. The laser of claim 10, wherein said reflecting device is operable as a Q-switch for said laser resonator.

17. The laser of claim 10, wherein said reflecting device is operable as a modulator.

18. A laser comprising:
a laser resonator having first and second reflectors said laser resonator having a longitudinal axis;
a gain-medium located in said laser resonator;
an arrangement for energizing said gain medium for generating laser radiation in said resonator;
said first reflector including first and second planar grids of parallel conductors, said grids being spaced apart and with planes thereof aligned parallel to each other with conductors in one of said grids aligned at an angle to conductors in the other, and with the spacing between said grids being variable; and
wherein, varying the spacing between said grids varies the reflectivity of said first reflector at a fundamental lasing wavelength of said laser radiation.

19. The laser of claim 18, wherein said alignment angle of said conductors is selectively variable, and wherein varying said angle varies the variation of reflectivity of said reflective device at said lasing wavelength per unit variation of the spacing of said grids.

20. The laser of claim 18, wherein said first and second reflectors are arranged as end-mirrors of said laser resonator.

21. The laser of claim 18, wherein said laser resonator is a folded resonator and further includes a third reflector, said second and third reflectors being arranged as end mirrors of said laser resonator and said first reflector being arranged as a fold mirror of said laser resonator.

22. The laser of claim 21, wherein said first reflector is operable as a Q-switch for said laser resonator.

23. The laser of claim 21, wherein said first reflector is operable as a modulator for said laser resonator.

24. The laser of claim 18, wherein said laser resonator is a folded resonator and further includes a third reflector, first and second reflectors being arranged as end mirrors of said laser resonator and said third reflector being arranged as a fold mirror of said laser resonator.

25. The laser of claim 24, wherein said first reflector is operable as a Q-switch for said laser resonator.

26. The laser of claim 25, wherein said first reflector is arranged as an output-coupling mirror for said laser resonator.

27. The laser of claim 24, wherein said first reflector is operable as a modulator for said laser resonator.

28. The laser of claim 27, wherein said first reflector is arranged as an output-coupling mirror for said laser resonator.

29. A laser comprising:
a laser resonator; and
a Q-switch defined by two spaced apart wire-grid polarizers having variable spacing therebetween.
